(19) United States
(12) Patent Application Publication
(10) Pub. No.: US 2005/0271241 A1
(43) Pub. Date: Dec. 8, 2005

(54) Speaker device

(76) Inventor: Tomoyuki Watanabe, Yamagata (JP)

Correspondence Address: YOUNG & THOMPSON, 745 SOUTH 23RD STREET, 2ND FLOOR, ARLINGTON, VA, 22202, US

(21) Appl. No.: 11/083,979

(22) Filed: Mar. 21, 2005

(30) Foreign Application Priority Data
Mar. 19, 2004 (JP) 2004-80137

(51) Int. Cl. H04R 1/00; H04R 9/06; H04R 11/02

(52) U.S. Cl. 381/407; 381/396

(57) ABSTRACT

A connecting member has a radiation structure. Concretely, plural openings are formed on a cylindrical portion of the connecting member. When a voice coil bobbin moves to a sound emitting side, a portion of the air in a space between a diaphragm and a conductive damper is inhaled to a space between the cylindrical portion and the voice coil bobbin through each opening of the connecting member. By the inhaled force, high temperature air around the voice coil is pushed out and discharged to a space on the side of the inner peripheral edge portion of a frame. When the voice coil bobbin moves to the side opposite to the sound emitting side, the air in the space between the voice coil bobbin and the plate is compressed, and air is discharged to the space between the inner peripheral wall of the voice coil bobbin and the magnetic circuit system.

### TECHNICAL FIELD

The present invention relates to a speaker device having a radiation structure.

### BACKGROUND ART

Conventionally, there is known an internal magnet type speaker device including a magnetic circuit including a plate-shaped magnet, a planar plate and a pot type yoke, and a vibrating system including a diaphragm, a damper, a connecting member made of a resin material, a voice coil, a voice coil bobbin and a frame.

In such the speaker device, the connecting member is supported by the voice coil bobbin, and various components (e.g., the diaphragm, the damper and the like) of the speaker device are mounted to the connecting member via the adhesive.

However, in the above-mentioned speaker device, since the magnetic circuit is housed in the frame, heat generated in the voice coil stays thereabouts, and radiation is inefficient. Thereby, the temperature of the air around the voice coil becomes high, and the connecting member made of the resin material and the like, having low rigidity and disposed thereabouts, is sometimes deformed by the heat. Thereby, the adhesion strength of the adhesive fixing the connecting member and the various components of the speaker device decreases, and the adhered portion sometimes peels off.

As the speaker device having the radiation structure, there is known a speaker having an opening formed on an end surface opposite to a bearing surface for supporting a magnetic circuit of a magnetic circuit supporting member, a through hole penetrating a peripheral surface of the magnetic circuit maintaining member and a radiation fin formed in a shape of a rib projecting from an inner wall of the magnetic circuit maintaining member, in order to sufficiently maintain a radiation effect of the heat generated in the voice coil, for example (see Japanese Patent Application Laid-Open under No. 2003-299185).

There is also known a speaker capable of radiating heat generated in the voice coil with high efficiency, by connecting a voice coil bobbin and a radiation pipe made of materials having thermal conductivity in a state that the thermal conduction is possible, and by disposing many radiation fins on an inner peripheral surface of the radiation pipe (see Japanese Patent Application Laid-Open under No. 2002-78084, for example).

Moreover, there is also known a speaker device capable of efficiently cooling the voice coil by using materials having good thermal conductivity for a bobbin and a center cap and by forming a slit on the bobbin (see Japanese Patent Application Laid-Open under No. 2002-142292, for example).

### DISCLOSURE OF THE INVENTION

As an object to be achieved by the present invention, the above described object is cited as an example. The present invention has its object to provide a speaker device capable of preventing an adhesive fixing a connecting member and various components of the speaker device from peeling off by efficiently radiating heat generated in a voice coil and the like.

According to one aspect of the present invention, there is provided a speaker device including: a frame; a magnetic circuit which includes a pot type yoke mounted on the frame; a damper which has an peripheral edge portion supported by the frame; a diaphragm which is disposed above the magnetic circuit and which has an outer peripheral edge portion supported by the frame; and a connecting member which is mounted to the damper and the diaphragm and which movably supports a voice coil bobbin above the magnetic circuit, wherein an opening serving as an air passage is formed on a side wall of the connecting member.

In the above speaker device, the voice coil bobbin disposed above the magnetic circuit is supported by the connecting member. The connecting member is mounted to the frame via the damper, the diaphragm and the like, and movably supports the voice coil bobbin in the axial direction of the speaker device. Since the area above the voice coil bobbin is structurally covered by the connecting member, the heat generated at the area in the vicinity of the voice coil is hardly radiated outside. Therefore, on the side wall of the connecting member, the opening serving as the air passage is formed. From the opening, the heat generated at the area in the vicinity of the voice coil of the speaker device can be radiated outside.

In a form of the above speaker device, the connecting member may have the opening at a position at which air in a vicinity of the voice coil is discharged to a space between the pot type yoke and an inner peripheral edge portion of the frame when the diaphragm is driven in a direction away from the magnetic circuit, and at which the air in the vicinity of the voice coil is discharged to a space between a bottom surface of the diaphragm and an area in a vicinity of an upper end of the frame when the diaphragm is driven in a direction close to the magnetic circuit.

In the form, when the diaphragm is driven in the direction away from the magnetic circuit, the air on the outer side of the connecting member is inhaled via the opening, and the air around the voice coil, whose temperature becomes high due to the heat generation of the voice coil, is pushed out and discharged to the space between the pot type yoke and the inner peripheral edge portion of the frame. In a preferred example, the frame may be preferably made of the metal material having the good thermal conductivity. Thereby, the high temperature air discharged to the space is cooled via the frame made of the metal material by exchanging the heat with the outside of the speaker device. Thus, the heat generated in the voice coil can be efficiently radiated.

On the contrary, when the diaphragm is driven in the direction close to the magnetic circuit, the air in the space between the voice coil bobbin and the magnetic circuit, which is compressed, is discharged to the space between the inner wall of the voice coil bobbin and the magnetic circuit, and is further discharged to the space between each outer wall of the voice coil and the voice coil bobbin and the inner wall of the connecting member. The air around the voice coil, whose temperature becomes high due to the discharged force, is pushed out and discharged to the space between the bottom surface of the diaphragm and the area in the vicinity of the upper end of the frame. In a preferred example, the frame may preferably have an opening at the position opposite to the outer side wall of the connecting member. Thereby, the high temperature air discharged to the space can be further discharged to the external space of the speaker device. Thereby, the heat generated in the voice coil can be efficiently radiated.

Like this, in the above speaker device, since the connecting member is cooled by efficiently radiating the heat generated in the voice coil, it can be prevented that the connecting member is deformed due to the heat generated by the voice coil. Thereby, the adhesion strength of the adhesive fixing the connecting member and the various components of the speaker device, e.g., the diaphragm, the damper and the like, never decreases. Thus, it can be prevented that the adhesive fixing them peels off the connecting member and the like.

In addition, in the above speaker device, the limit value of the withstand input to the voice coil decreases with the temperature of the voice coil increasing. However, as described above, since the air around the voice coil is cooled by efficiently radiating the heat generated in the voice coil, the inside of the speaker device can be efficiently cooled. Thus, the limit value of the withstand input to the voice coil can be set to the high value.

In a form of the above speaker device, plural openings may be formed on the side wall of the connecting member with fixed spaces therebetween. Thereby, the heat generated in the voice coil can be efficiently radiated. By forming the plural openings on the connecting member, the connecting member can be made light. Since the voice coil bobbin is easily driven, the diaphragm can be vibrated at an appropriate number of vibrations. Therefore, the sensitivity of the speaker device can be improved.

According to another aspect of the present invention, there is provided a speaker device including: a frame; a magnetic circuit which includes a pot type yoke mounted on the frame; a damper which has an outer peripheral edge portion supported by the frame; and a connecting member which is mounted to the damper and which movably supports a voice coil bobbin above the magnetic circuit, wherein plural ribs are formed on at least one of an outer peripheral wall and an inner peripheral wall of the connecting member such that a longitudinal direction of the rib is in parallel with a movement direction of the voice coil bobbin.

In the above speaker device, the plural projecting ribs are formed in a direction in parallel with the magnitude direction of the voice coil bobbin on at least one of the outer peripheral wall and the inner peripheral wall of the connecting member. By the upward and downward movement of the voice coil bobbin at the time of driving the speaker device, the operation of the ribs sometimes causes wind around the inner and outer circumferences of the connecting member. Thereby, the heat generated in the voice coil can be efficiently radiated. In addition, by selecting the material of the connecting member, the plural ribs can function as the radiation fins.

In a preferred example, the plural ribs may be preferably formed on the connecting member in a circumferential direction with fixed spaces there between respectively, and may be preferably formed from an area in a vicinity of an upper end of the connecting member to an area in a vicinity of a lower end thereof.

Like this, since the connecting member is cooled by efficiently radiating the heat generated in the voice coil, it can be prevented that the connecting member is deformed due to the heat generated by the voice coil. Thereby, the adhesion strength of the adhesive fixing the connecting member and the various components of the speaker device, e.g., the diaphragm, the damper and the like, never decreases. Therefore, it can be prevented that the adhesive peels off the connecting member and the like.

In addition, in the above-mentioned speaker device, the limited value of the with stand input to the voice coil decreases with the temperature of the voice coil increasing. However, as described above, since the air around the voice coil is cooled by efficiently radiating the heat generated in the voice coil, the inside of the speaker device can be efficiently cooled. Therefore, the limit value of the withstand input to the voice coil can be set to the high value.

Moreover, since the plural ribs are formed on the outer side wall and/or the inner side wall of the above connecting member, the strength of the connecting member can be enhanced.

### BRIEF DESCRIPTION OF THE DRAWINGS

FIG. 1 shows a sectional view of a speaker device according to an embodiment of the present invention;

FIG. 2 is a perspective view schematically showing a connecting member according to a first embodiment;

FIG. 3 is a sectional view of the speaker device for explaining a radiation operation of the connecting member according to the first embodiment;

FIGS. 4A and 4B are perspective views schematically showing the connecting member according to a second embodiment;

FIG. 5 is a sectional view of the speaker device for explaining the radiation operation of the connecting member according to the second embodiment;

FIG. 6 is a perspective view schematically showing the connecting member according to a third embodiment;

FIG. 7 is a sectional view of the speaker device for explaining the radiation operation of the connecting member according to the third embodiment;

FIG. 8 is a perspective view schematically showing the connecting member according to a fourth embodiment; and

FIG. 9 is a sectional view of the speaker device for explaining the radiation operation of the connecting member according to the fourth embodiment.

### BEST MODE FOR CARRYING OUT THE INVENTION

A preferred embodiment of the present invention will be explained hereinafter with reference to the drawings. In the present embodiment, by providing a radiation structure on the connecting member, the heat generated in the voice coil is effectively radiated outside. Thereby, the deformation of the connecting member due to the heat is prevented, and peeling of the adhesive fixing the connecting member and the various components of the speaker device is prevented.

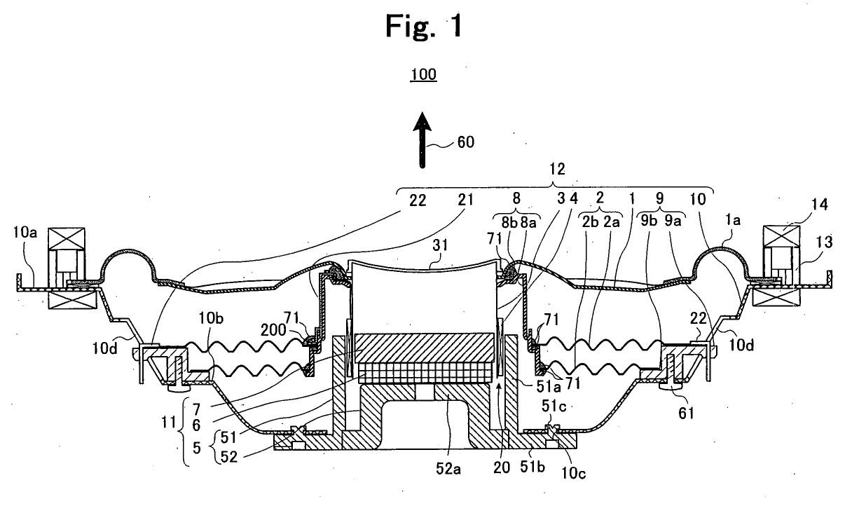

A general construction of a speaker device 100 according to the embodiment of the present invention will be schematically shown in FIG. 1. The speaker device 100 of this embodiment can be preferably used as a non-vehicle speaker. FIG. 1 shows a sectional view when cutting the speaker device 100 by a plane including a central axis thereof. A construction and the like of the speaker device 100 of this embodiment will be explained hereinafter with reference to FIG. 1.

As shown in FIG. 1, the speaker device 100 mainly includes a vibrating system 12 having a frame 10, a support member 9, a voice coil bobbin 3, a connecting member 8, a damper 2, terminal members 21, terminal members 22, a voice coil 4 and a diaphragm 1, a magnetic circuit system 11 having a pot type yoke 5, a magnet 6 and a plate 7, an anti-dust cap 31, and other various kinds of members.

First, each component of the vibrating system 12 will be explained.

Various components of the speaker device 100 are fixed to the frame 10, and the frame 10 has the function of supporting these components. The frame 10 is made of a metal material of good thermal conductivity. Therefore, the frame 10 has the function as a medium for giving and receiving heat to and from an external space of the speaker device 100 and its internal space. The frame 10 is formed into a pan-shape or pot-shape which is opened upward, and has a first flange part 10a formed at the top part for supporting an outer peripheral edge portion and the like of the diaphragm 1, a second flange part 10b formed at an intermediate part for supporting the support member 9, openings 10c formed in an inner peripheral edge portion, and a plurality of openings 10d formed at a side wall between the first flange part 10a and the second flange part 10b. A plurality of openings 10c are formed with fixed spaces therebetween in a circumferential direction of the inner peripheral edge portion. Each of the projecting portions 51c of the pot type yoke 5 before deformation, which will be described later, is inserted into each of the openings 10c.

The support member 9 is formed of, for example, a resin material, and is formed into a substantially annular shape in the plane view. The support member 9 is formed into a step shape in the sectional view, and has a top surface 9a and a top surface 9b. The support member 9 is mounted to the second flange part 10b by a fixing member 61 such as a male screw and a bolt.

The voice coil bobbin 3 is formed into a substantially cylindrical shape. The voice coil 4 is wound around an outer peripheral wall of a lower end portion of the voice coil bobbin 3. The inner peripheral wall of the lower end portion of the voice coil bobbin 3 is opposed to outer peripheral walls of the planar magnet 6 and plate 7 with a fixed space from them. The outer peripheral wall of the lower end portion of the voice coil bobbin 3 is opposed to an outer peripheral wall of an upper end portion of a pole piece 5 at a fixed space from it. A clearance (magnetic gap 20) is formed between an inner peripheral wall of the upper end portion of the pole piece 5 and an outer peripheral wall of the plate 7.

The connecting member 8 is formed of, for example, a resin material, has a cylindrical portion 8a formed into a substantially cylindrical shape and a bent portion 8b formed in a fashion being bent inwardly from an upper end of the cylindrical portion 8a, and is made by integrally forming them. An inner peripheral edge portion of the connecting member 8, namely, an inner peripheral edge portion of the bent portion 8b is fixed to an area in the vicinity of the upper end of the outer peripheral wall of the voice coil bobbin 3. The connecting member 8 has a structure for efficiently radiating the heat generated in the voice coil 4, which is a characteristic of the present invention and will be described later.

The damper 2 has a conductive damper 2a and an ordinary damper 2b. The conductive damper 2a is disposed above the damper 2b. The conductive damper 2a has a plurality of conductive members not shown. Each of the conductive members is sewn onto a top surface of the conductive damper 2a from the inner peripheral edge portion of the conductive damper 2a to its outer peripheral edge portion. The outer peripheral edge portion of the damper 2b is fixed to the top surface 9b of the support member 9 and the inner peripheral edge portion of the damper 2b is fixed to a lower end portion of the connecting member 8 via an adhesive 71. Meanwhile, the outer peripheral edge portion of the conductive damper 2a is fixed to the top surface 9a of the support member 9 and the inner peripheral edge portion of the conductive damper 2a is fixed to an area in the vicinity of the lower end of the connecting member 8 via the adhesive 71.

The terminal member 21 is a member such as metal having conductivity, and a plurality of terminal members 21 are provided. Each terminal member 21 is mounted to the connecting member 8. The upper end of each of the terminal members 21 is electrically connected to each lead wire of the voice coil 4, and a lower end of each of the terminal members 21 is electrically connected to each of the conductive members of the conductive damper 2a.

The terminal member 22 is a member having conductivity, and a plurality of terminal members 22 are provided. Each of the terminal members 22 is fixed to the top surface 9a of the support member 9. One end of each of the terminal members 22 is electrically connected to each of the conductive members of the conductive damper 2a, and the other end of each of the terminal members 22 is electrically connected to a relay wiring at an amplifier side not shown.

The voice coil 4 has a pair of positive/negative lead wires (not shown). A lead wire at the positive side is an input wiring for an L (or R) channel signal, and a lead wire at the negative side is an input wiring for a ground (GND: ground) signal. Each lead wire is electrically connected to the upper end of each of the terminal members 21 as described above. Therefore, an electric signal of one channel is inputted from the amplifier side into the voice coil 4 via each of the terminal members 22, each of the conductive members of the conductive damper 2a, each of the terminal members 21 and each of the lead wires.

The diaphragm 1 is formed into a substantially planer shape to be made thin. Various kinds of materials such as paper, polymer, and metal can be applied to the diaphragm 1 in accordance of the various kinds of use purposes. The edge portion 1a which is a separate piece from the diaphragm 1 is mounted to an outer peripheral edge portion of the diaphragm 1. The outer peripheral edge portion of the diaphragm 1 is fixed to the first flange part 10a. Meanwhile, an inner peripheral edge portion of the diaphragm 1 is fixed to the area in the vicinity of the upper end of the outer peripheral wall of the voice coil bobbin 3. The inner peripheral edge portion of the diaphragm 1 and the bent portion 8b of the connecting member 8 are fixed via the adhesive 71.

Next, each component of the magnetic circuit 11 will be explained.

The magnetic circuit system 11 is constructed as the internal magnet type magnetic circuit. This magnetic circuit has the pot type yoke 5, the planar magnet 6 and the planar plate 7.

The pot type yoke 5 has a body part 51 and a bottom part 52, and they are bonded together. The pot type yoke 5 is mounted on frame 10.

The body part 51 has a cylindrical portion 51a, a flange part 51b, and projecting portions 51c projecting upward from the top surface of the flange part 51b, and is formed by integrating them. The cylindrical portion 51a is formed into a substantially cylindrical shape. The cylindrical portion 51a extends upward from the area in the vicinity of the inner circumference of the flange part 51b to the position in the vicinity of the plate 7. The flange part 51b extends in the outward direction substantially perpendicularly from the position in the vicinity of the lower end of the outer peripheral wall of the cylindrical portion 51a. The inner peripheral edge portion of the frame 10 is mounted to the top surface of the flange part 51b. The projecting portion 51c is formed into the columnar shape and a plurality of projecting portions 51c are formed on the top surface of the flange part 51b with fixed spaces from each other. Each of the projecting portions 51c has the function of fixing the inner peripheral edge portion of the frame 10 by being caulked.

The bottom part 52 has the sectional shape of substantially inversed recessed shape. The bottom part 52 has a mounting portion 52a which has substantially the same size as the diameters of the planer magnet 6 and the planar plate 7. The outer peripheral edge portion of the bottom part 52 is connected to the body part 51.

The planar magnet 6 is fixed onto the mounting portion 52a of the bottom part 52 of the pot type yoke 5. The planar plate 7 is fixed onto the magnet 6. In the magnetic circuit system 11, the magnetic circuit is constructed by the magnet 6 and the plate 7, and magnetic flux of the magnet 6 is concentrated at the magnetic gap 20 formed between the outer peripheral wall of the plate 7 and the inner peripheral wall of the pot type yoke 5.

The anti-dust cap 31 is mounted to the upper end portion of the voice coil bobbin 3 via the adhesive so as to close the top surface of the voice coil bobbin 3. Thereby, the anti-dust cap 31 has the function of preventing a foreign matter or the like from entering the inside of the speaker device 100.

Next, various kinds of component members will be explained.

Various kinds of component members include a packing 13, a buffer member 14 and the like.

The packing 13 is formed into an annular shape and is the member having insulating property. As the material for the packing 13, for example, a resin material is preferable. The bottom surface of the packing 13 is fixed to the first flange part 10a and the outer peripheral edge part of the edge portion 1a. Thereby, the outer peripheral edge part of the diaphragm 1 and the edge portion 1a is sandwiched by the packing 13 and the first flange part 10a.

The buffer member 14 has the function as the buffer material when the speaker device 100 is mounted to a predetermined position of the vehicle, for example, and has the function and the like of preventing the vibration from the outside from being transmitted to the body of the speaker device 100. Therefore, as the material of the buffer member 14, for example, a member having cushioning property such as sponge is preferable. The buffer member 14 has a rod shape before being mounted, and an adhesive is applied to one side surface, or a double-side adhesive tape is attached to one side surface. The buffer member 14 is attached on the upper surface of the packing 13 via the adhesive or the double-side adhesive tape in the state in which it is deformed in an annular shape.

In the speaker device 100 which is described above, an electric signal outputted from the amplifier is supplied to the voice coil 4 via each of the terminal members 22, each of the conductive members of the conductive damper 2a, each of the terminal members 21 and each lead wire of the voice coil 4. Thereby, driving force occurs to the voice coil 4 in the magnetic gap 20, and vibrates the diaphragm 1 in the axial direction of the speaker device 100. Thus, the speaker device 100 emits acoustic waves in the direction of the arrow 60.

[Radiation Structure of Connecting Member]

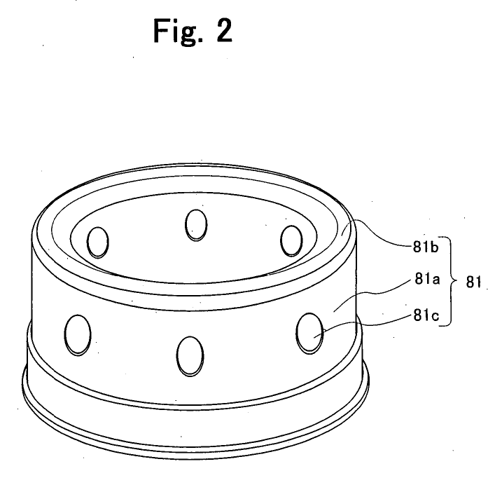

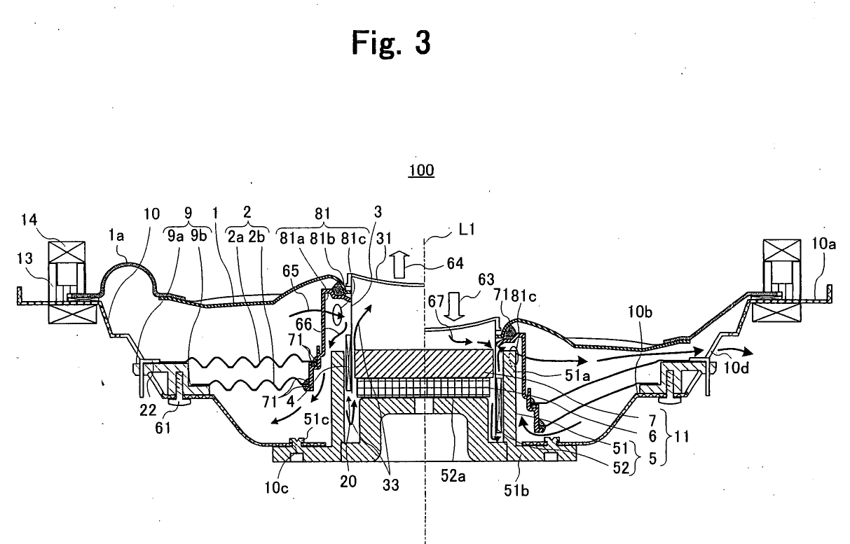

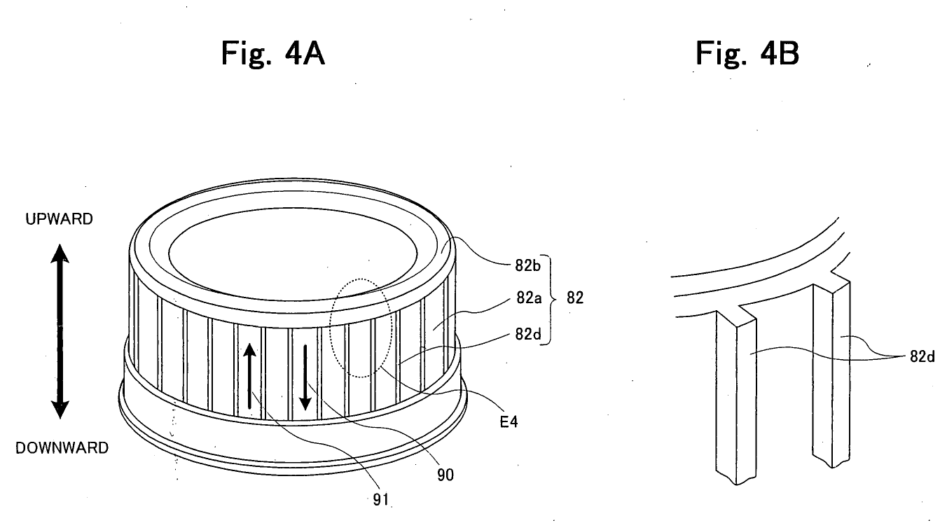

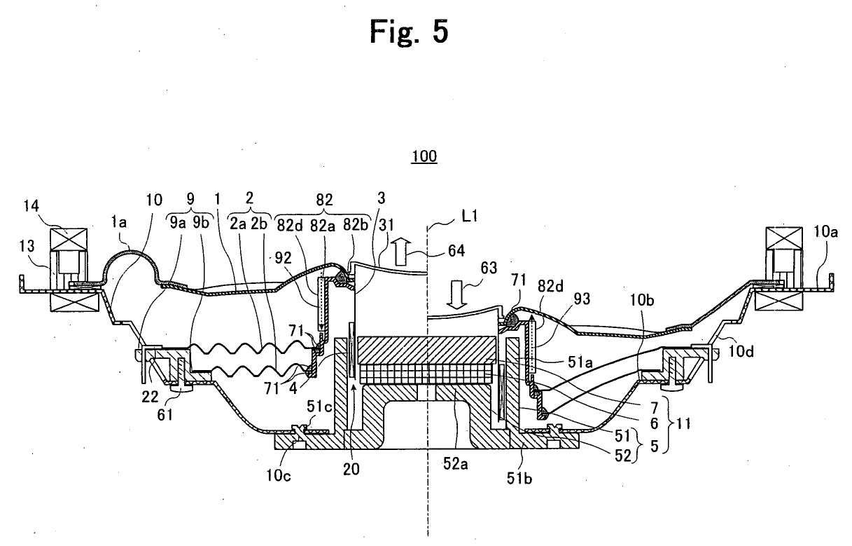

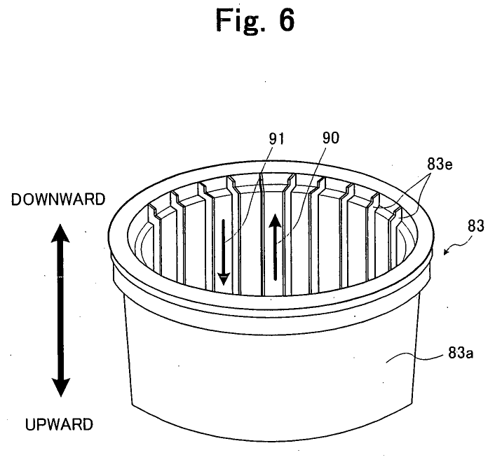

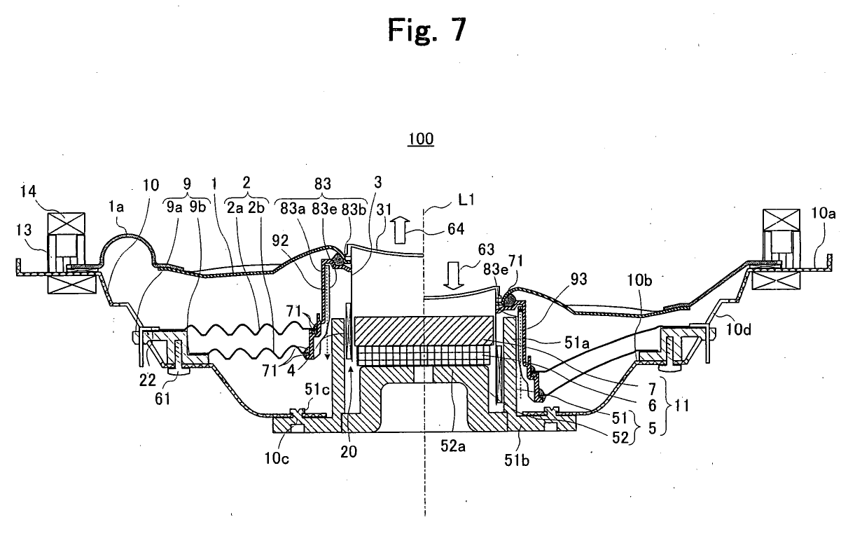

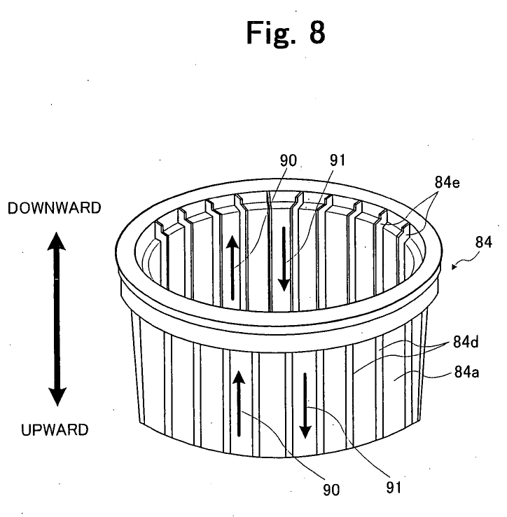

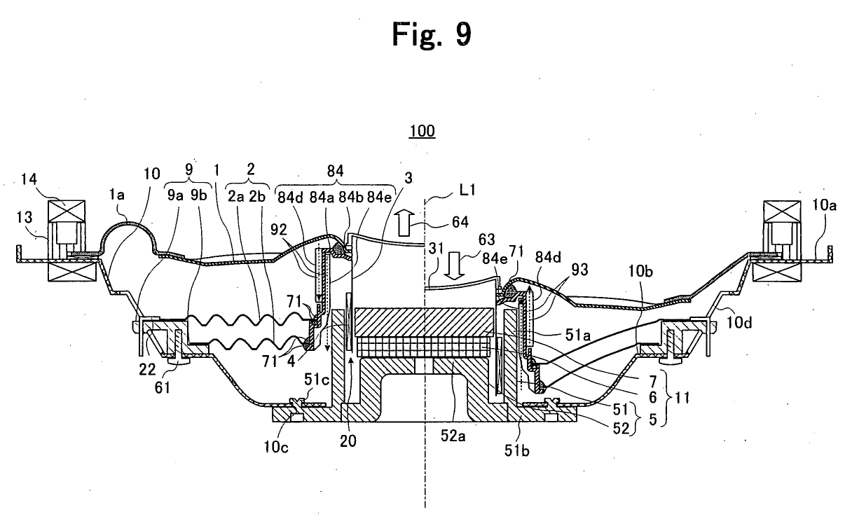

Next, the description will be given of the connecting member having the radiation structure for efficiently radiating the heat generated in the voice coil 4, with reference to FIG. 2 to FIG. 9. FIG. 2 schematically shows a perspective view of the connecting member having the radiation structure according to a first embodiment. FIG. 3 is a sectional view of the speaker device 100 for explaining the radiation operation by the connecting member of the first embodiment. FIG. 4A schematically shows a perspective view of the connecting member having the radiation structure according to a second embodiment. FIG. 4B shows a perspective view in which an area E4 shown in FIG. 4A is enlarged. FIG. 5 is a sectional view of the speaker device 100 for explaining the radiation operation by the connecting member of the second embodiment. FIG. 6 schematically shows a perspective view of the connecting member having the radiation structure according to a third embodiment. FIG. 7 is a sectional view of the speaker device 100 for explaining the radiation operation by the connecting member of the third embodiment. FIG. 8 schematically shows a perspective view of the connecting member having the radiation structure according to a fourth embodiment. FIG. 9 is a sectional view of the speaker device 100 for explaining the radiation operation by the connecting member of the fourth embodiment. For convenience of the explanation, in FIG. 3, FIG. 5 and FIG. 7, a condition that the voice coil bobbin 3 and the like move to the sound emitting side is shown on the left side with respect to a central axis L1 of the speaker device 100, and a condition that the voice coil bobbin 3 and the like move to the side opposite to the sound emitting side is shown on the right side.

### First Embodiment

In the first embodiment, by forming plural openings on the cylindrical portion of the connecting member, the heat generated in the voice coil 4 can be efficiently radiated. Thereby, the deformation of the connecting member due to the heat is avoided, and it is prevented that the adhesive 71 fixing the connecting member and the damper 2 peels off.

First, the description will be given of the structure of a connecting member 81 having the radiation structure applicable to the speaker device 100. As shown in FIG. 2, the basic structure of the connecting member 81 is similar to the structure of the above-mentioned connecting member 8, and the connecting member.81 has a cylindrical portion 81a and a bent portion 81b. However, the connecting member 81 is different from the connecting member 8 in that the cylindrical portion 81a of the connecting member 81 has plural openings 81c.

Each opening 81c is formed at a position at which the air around the voice coil 4 is discharged to the space between the outer peripheral wall of the cylindrical portion 51a and the inner peripheral edge portion of the frame 10 when the diaphragm 1 is driven in the direction away from the magnetic circuit system 11, and at which the air around the voice coil 4 is discharged to the space between the bottom surface of the diaphragm 1 and the area in the vicinity of the upper end of the frame 10 when the diaphragm 1 is driven in the direction close to the magnetic circuit system 11. The plural openings 81c are formed on the outer peripheral wall of the cylindrical portion 81a with fixed spaces there between. Each opening 81c penetrates the cylindrical portion 81a from the inner peripheral wall thereof to the outer peripheral wall thereof.

First, before the operation of the opening 81c is explained, the description will be given of how the adhesive 71 fixing the connecting member 81 and the damper 2 peels off due to the heat generation of the voice coil 4, with reference to FIG. 3. In the speaker device 100, the electric signal is inputted from the amplifier side to the voice coil 4, and the driving power is generated in the voice coil 4 in the magnetic gap 20. The voice coil bobbin 3 and the like vibrate in the directions of the arrows 63 and 64. If the speaker device 100 is driven in a predetermined time period, the voice coil 4 generates the heat.

Thereby, the temperature of the air around the voice coil 4 becomes high. Unless the speaker device 100 has the radiation structure, the heat generated in the voice coil 4 cannot be efficiently radiated. Therefore, the connecting member disposed near the voice coil 4 may be deformed due to the heat. The adhesion strength of the adhesive 71 fixing the connecting member and the damper 2 and the adhesive 71 fixing the connecting member and the diaphragm 1 is decreased due to the heat, and hence the adhesive 71 sometimes peels off the connecting member.

However, if the connecting member 81 according to the first embodiment is applied to the speaker device 100, such the problem can be solved. Namely, instead of the above-mentioned connecting member 8, the connecting member 81 is applied to the speaker device 100 shown in FIG. 3. The portion of the speaker device 100 to which the connecting member 81 is mounted and the structure thereof are similar to those of the connecting member 8.

When the speaker device 100 is driven and the voice coil bobbin 3 moves to the sound emitting side, i.e., in the direction of an arrow 64, one portion of the air in the space between the diaphragm 1 and the conductive damper 2a is inhaled to the space between the cylindrical portion 81a and the voice coil bobbin 3 and to the space between the voice coil bobbin 3 and the plate 7 through each opening 81c of the connecting member 81 respectively, as shown by an arrow 65. Therefore, as shown by an arrow 66, by the inhaled force, the one portion of the high temperature air around the voice coil 4 is pushed out and discharged to the lower end portion of the connecting member 81, and is further discharged to the space between the outer peripheral wall of the pot type yoke 5 and the inner peripheral edge portion of the frame 10. The high temperature air discharged into the space, whose heat is exchanged with the external space of the speaker device 100 by the frame 10 made of the metal material having the thermal conductivity, is cooled. By cooling the air around the voice coil 4, the connecting member 81 is also cooled. By the inhaled force, the one portion of the high temperature air around the voice coil 4 is brought to the space between the inner peripheral wall of the body part 51 and the outer peripheral wall of the bottom part 52 and is further brought to the space in the voice coil bobbin 3, as shown by the arrow 33.

On the contrary, when the speaker device 100 is driven and the voice coil bobbin 3 and the like move on the side opposite to the sound emitting side, i.e., in the direction of the arrow 63, the high temperature air in the space between the voice coil bobbin 3 and the plate 7 is compressed, and is discharged to the space between the inner peripheral wall of the voice coil bobbin 3 and the magnetic circuit system 11 as shown by an arrow 67. The high temperature air is further discharged to the space between each outer peripheral wall of the voice coil 4 and the voice coil bobbin 3 and the cylindrical portion 51a. By the discharging force, the discharged high temperature air and the high temperature air around the voice coil 4 are pushed out and discharged to the space between the diaphragm 1 and the conductive damper 2a via each opening 81c of the connecting member 81. Further, they are discharged to the external space of the speaker device 100 through each opening 10d of the frame 10. At this time, the air in the space between the frame 10 and the damper 2b is discharged to the space between the outer peripheral wall of the body part 51 and the inner peripheral wall of the connecting member 8 as shown by the arrow in FIG. 3. Moreover, the discharged air is discharged to the external space of the speaker device 100 through each opening 81c, as described above. Thereby, the air around the voice coil 4 is cooled, and the connecting member 81 is also cooled.

As described above, if the connecting member 81 having the plural openings 81c is applied to the speaker device 100, the heat generated in the voice coil 4 can be efficiency radiated. Thereby, since the air around the voice coil 4 is cooled, the connecting member 81 is never deformed due to the heat. In addition, the adhesion strength of the adhesive 71 fixing the connecting member 81 and the damper 2 and the adhesive 71 fixing the connecting member 81 and the diaphragm 1 is never decreased, and it can be possible to prevent the adhesive 71 from peeling off the connecting member 81.

In the speaker device 100, generally, the limit value of the withstand input to the voice coil 4 decreases with the temperature of the voice coil 4 increasing. However, in the first embodiment, since the air around the voice coil 4 is cooled as described above, the inside of the speaker device 100 can be efficiently cooled. Therefore, the limit value of the withstand input to the voice coil 4 can be set to the high value.

Moreover, in the above connecting member 81, since the plural openings 81c are formed on the cylindrical portion 81a, the connecting member 81 can be correspondently made light. Thereby, since driving the voice coil bobbin 3 becomes easy, the diaphragm 1 can be vibrated at the appropriate number of vibrations. Thus, the sensitivity of the speaker device 100 can be improved.

### Second Embodiment

In the second embodiment, by forming the plural ribs on the outer peripheral wall of the cylindrical portion of the connecting member, the heat generated in the voice coil 4 is efficiently radiated. Thereby, the connecting member of the high temperature due to the heat of the voice coil 4 is cooled, and the deformation of the connecting member due to the heat is prevented. Further, the adhesive 71 fixing the connecting member and the damper 2 is prevented from peeling off.

First, the description will be given of a structure of a connecting member 82 having the radiation structure applicable to the speaker device 100. As shown in FIG. 4A and FIG. 5, the basic structure of the connecting member 82 is similar to the structure of the above-mentioned connecting member 8, and the connecting member 82 has a cylindrical portion 82a and a bent portion 82b. However, on the outer peripheral wall of the cylindrical portion 82a of the connecting member 82, plural projecting ribs 82d are formed, and the connecting member 82 is different from the connecting member 8 in this point. Each rib 82d extends from the upper end of the connecting member 82 to the lower end thereof. As enlarged and shown in FIG. 4B, each rib 82d is a rectangular parallelepiped projection for example, and is formed on the outer peripheral wall of the cylindrical portion 82a with fixed spaces therebetween. Particularly, each rib 82d has the longitudinal direction in the direction in parallel with the vibrating direction of the voice coil bobbin 3, and is formed on the outer peripheral wall of the cylindrical portion 82a. Thus, at the time of driving the speaker device 100, each rib 82d can prevent the diaphragm 1 from receiving unnecessary air vibration. Thereby, it can be prevented to give an adverse effect to the sound of the speaker device 100.

At the time of driving the speaker device 100, each rib 82d serves to cool the connecting member 82. Concretely, as shown in FIG. 4A, when the connecting member 82 is driven upward (on the sound emitting side), by the operation of the ribs 82d, the air between the pair of ribs 82d flows in the direction opposite to the operation direction of the connecting member 82, i.e., in the direction of an arrow 90. Thereby, the wind is generated around the outer peripheral wall of the connecting member 82. On the contrary, when the connecting member 82 is driven downward (on the side opposite to the sound emitting side), by the operation of the ribs 82d, the air between the pair of ribs 82d flows in the direction opposite to the operation direction of the connecting member 82, i.e., in the direction of an arrow 91. Thereby, the wind is generated around the outer peripheral wall of the connecting member 82. By generating the wind around the outer peripheral wall of the connecting member 82 by the operation of the respective ribs 82d, the heat of the voice coil 4 can be efficiently radiated, and the connecting member 82 can be cooled.

Next, such the operation will be explained with reference to FIG. 5. In the first embodiment, it is explained how the adhesive 71 fixing the connecting member 82 and the damper 2 peels off due to the heat generation of the voice coil 4. Therefore the explanation thereof is omitted below.

If the connecting member 82 according to the second embodiment is applied to the speaker device 100, the problem explained in the first embodiment can be solved. Instead of the above-mentioned connecting member 8, the connecting member 82 is applied to the speaker device 100 shown in FIG. 5. The portion of the speaker device 100 to which the connecting member 82 is mounted and the structure thereof are similar to those of the connecting member 8.

When the speaker device 100 is driven and the voice coil bobbin 3 and the like move to the sound emitting side, i.e., in the direction of the arrow 64, by the operation of each rib 82d, the air around the outer peripheral wall of the cylindrical portion 82a flows in the direction of an arrow 92. Thereby, the wind is generated around the outer peripheral wall of the cylindrical portion 82a. On the contrary, when the speaker device 100 is driven and the voice coil bobbin 3 and the like move to the side opposite to the sound emitting side, i.e., in the direction of the arrow 63, by the operation of each rib 82d, the air around the outer peripheral wall of the cylindrical portion 82a flows in the direction of an arrow 93. Thereby, the wind is generated around the outer peripheral wall of the cylindrical portion 82a.

At this time, the temperature of the air in the space between the outer peripheral wall of the voice coil bobbin 3 and the inner wall of the connecting member 82 becomes high due to the heat generated by the voice coil 4. By the effect of the heat, the temperature of the inner wall of the connecting member 82 becomes high. However, by the above-mentioned wind caused by the operation of each rib 82d, the upper surface of the bent portion 82 and the outer peripheral wall of the cylindrical portion 82a are cooled. Thereby, the heat is exchanged between the inner wall of the connecting member 82 and the outer wall thereof, and the heat generated in the voice coli 4 can be efficiently radiated. Thus, the temperature of the connecting member 82 does not become so high that the deformation due to the heat occurs.

If the connecting member 82 having the plural ribs 82d is applied to the speaker device 100, the heat generated in the voice coil 4 can be efficiently radiated, and the connecting member 82 can be efficiently cooled. Thereby, it can be prevented that the connecting member 82 is deformed due to the heat. Also, the adhesion strength of the adhesive 71 fixing the connecting member 82 and the damper 2 and the adhesive 71 fixing the connecting member 82 and the diaphragm 1 is never decreased, and it can be prevented that the adhesive 71 peels off the connecting member 82.

In addition, in the speaker device 100, generally, the limit value of the withstand input to the voice coil 4 decreases with the temperature of the voice coil 4 increasing. However, in the second embodiment, since the air around the outer peripheral wall of the connecting member 82 is cooled as described above, the inside of the speaker device 100 can be efficiently cooled. Thereby, the limit value of the withstand input to the voice coil 4 can be set to the high value.

Moreover, in the above-mentioned connecting member 82, since the plural ribs 82d are formed on the outer peripheral wall of the cylindrical portion 82a, the strength of the connecting member 82 can be enhanced.

### Third Embodiment

In the third embodiment, by forming the plural ribs on the inner peripheral wall of the cylindrical portion of the connecting member, the heat generated in the voice coil 4 is efficiently radiated. Thereby, the high temperature connecting member due to the heat of the voice coil 4 is cooled, and the deformation of the connecting member due to the heat is prevented. Further, it is prevented that the adhesive 71 fixing the connecting member and the damper 2 peels off.

First, the description will be given of a structure of a connecting member 83 having the radiation structure applicable to the speaker device 100. As shown in FIG. 6 and FIG. 7, the basic structure of the connecting member 83 is similar to the structure of the above-mentioned connecting member 8, and the connecting member 83 has a cylindrical portion 83a and a bent portion 83b. However, the connecting member 83 has plural ribs 83e on the inner peripheral wall of the cylindrical portion 83a, and the connecting member 83 is different from the connecting member 8 in this point. As shown in FIG. 6, each rib 83e extends from the upper end of the cylindrical portion 83a to the lower end thereof, and projects from the inner peripheral wall of the cylindrical portion 83a to the central axis thereof. As shown in FIG. 6, each rib 83e is formed on the inner peripheral wall of the cylindrical portion 83a with fixed spaces therebetween. Thus, at the time of driving the speaker device 100, each rib 83e prevents the diaphragm 1 from receiving the unnecessary air vibration. Thereby, it can be prevented to give the adverse effect to the sound of the speaker device 100.

Each rib 83e serves to cool the connecting member 83 at the time of driving the speaker device 100. Concretely, as shown in FIG. 6, when the connecting member 83 is driven upward (on the sound emitting side), by the operation of the rib 83e, the air between the pair of ribs 83e flows in the direction opposite to the operation direction of the connecting member 83, i.e., in the direction of the arrow 90. Since FIG. 6 is the perspective view in which the connecting member 83 is observed from the bottom side, the direction that the connecting member 83 is driven upward (sound emitting side) is shown by the downward arrow in FIG. 6. Thereby, the wind is generated around the inner peripheral wall of the connecting member 83. On the contrary, when the connecting member 83 is driven downward (on the side opposite to the sound emitting side), by the operation of the rib 83e, the air between the pair of ribs 83e flows in the direction opposite to the operation direction of the connecting member 83, i.e., in the direction of the arrow 91. Thereby, the wind is generated around the inner peripheral wall of the connecting member 83. Like this, by generating the wind around the inner peripheral wall of the connecting member 83 by each rib 83e, the heat of the voice coil 4 can be efficiently radiated, and the connecting member 83 can be cooled.

Next, such the operation will be explained with reference to FIG. 7.

If the connecting member 83 according to the third embodiment is applied to the speaker device 100, the problem explained in the first embodiment can be solved. Instead of the above-mentioned connecting member 8, the connecting member 83 is applied to the speaker device 100 show in FIG. 7. The portion of the speaker device 100 to which the connecting member 83 is mounted and the structure thereof are similar to those of the connecting member 8.

When the speaker device 100 is driven and the voice coil bobbin 3 and the like move to the sound emitting side, i.e., in the direction of the arrow 64, by the operation of each rib 83e, the air around the inner peripheral wall of the cylindrical portion 83a flows in the direction of the arrow 92. Thereby, the wind is generated around the inner peripheral wall of the cylindrical portion 83a. On the contrary, when the speaker device 100 is driven and the voice coil bobbin 3 and the like move to the side opposite to the sound emitting side, i.e., in the direction of the arrow 63, by the operation of each rib 83e, the air around the inner peripheral wall of the cylindrical portion 83a flows in the direction of the arrow 93. Thereby, the wind is generated around the inner peripheral wall of the cylindrical portion 83a.

The temperature of the air in the space between the outer peripheral wall of the voice coil bobbin 3 and the inner wall of the connecting member 83 becomes high due to the heat generated by the voice coil 4. By the effect of the heat, the temperature of the inner wall of the connecting member 83 becomes high. However, by the wind generated by the above-mentioned operation of each rib 83e, the bottom surface of the bent portion 83 and the inner peripheral wall of the cylindrical portion 83a are cooled. Thereby, the heat generated in the voice coil 4 can be efficiently radiated. Thus, the temperature of the connecting member 83 does not become so high that the deformation due to the heat occurs.

If the connecting member 83 having the plural ribs 83e is applied to the speaker device 100, the heat generated in the voice coil 4 can be efficiently radiated, and the connecting member 83 can be effectively cooled. Thereby, it can be prevented that the connecting member 83 is deformed by the heat. In addition, the adhesion strength of the adhesive 71 fixing the connecting member 83 and the damper 2 and the adhesive 71 fixing the connecting member 83 and the diaphragm 1 is never decreased, and it can be prevented that the adhesive 71 peels off the connecting member 83.

Generally, in the speaker device 100, the limit value of the withstand input to the voice coil 4 decreases with the temperature of the voice coil 4 increasing. However, in the third embodiment, since the air around the inner peripheral wall of the connecting member 83 is cooled as described above, the inside of the speaker device 100 can be efficiently cooled. Therefore, the limit value of the withstand input to the voice coil 4 can be set to the high value.

Moreover, since the above-mentioned connecting member 83 has the plural ribs 83e on the inner peripheral wall of the cylindrical portion 83a, the strength of the connecting member 83 can be enhanced.

### Fourth Embodiment

In the fourth embodiment, a radiation structure obtained by combining the second and third embodiments is employed. Namely, in the fourth embodiment, by forming the plural ribs on the inner and outer peripheral walls of the cylindrical portion of the connecting member, the heat generated in the voice coil 4 can be efficiently radiated. Thereby, the connecting member is cooled, and the deformation of the connecting member due to the heat is prevented. It is prevented that the adhesive 71 fixing the connecting member and the damper 2 peels off.

First, the description will be given of a structure of a connecting member 84 having the radiation structure applicable to the speaker device 100. As shown in FIG. 8 and FIG. 9, the basic structure of the connecting member 84 is similar to the structure of the above-mentioned connecting member 8, and the connecting member 84 has a cylindrical portion 84a and a bent portion 84b. However, the connecting member 84 has plural ribs 84e on the inner peripheral wall of the cylindrical portion 84a and plural ribs 84d on the outer peripheral wall of the cylindrical portion 84a, and the connecting member 84 is different from the connecting member 8 in this point. As shown in FIG. 8, each rib 84e extends from the upper end of the cylindrical portion 84a to the lower end thereof, and projects from the inner peripheral wall of the cylindrical portion 84a to the central axis thereof. As shown in FIG. 8, each rib 84e is formed on the inner peripheral wall of the cylindrical portion 84a with fixed spaces therebetween. On the contrary, the structure of each rib 84d is similar to the structure of the second embodiment. Each rib 84d extends from the upper end of the cylindrical portion 84a to the lower end thereof, and projects from the outer peripheral wall of the cylindrical portion 84a to the outside. As shown in FIG. 8, each rib 84d is formed on the outer peripheral wall of the cylindrical portion 84a with the fixed spaces therebetween. Thus, at the time of driving the speaker device 100, each of the ribs 84e and 84d can prevent the diaphragm 1 from receiving the unnecessary air vibration. Thereby, it can be prevented to give the adverse effect to the sound of the speaker device 100.

At the time of driving the speaker device 100, each of the ribs 84e and 84d serves to cool the connecting member 84. Concretely, as shown in FIG. 8, when the connecting member 84 is driven upward (on the sound emitting side), by the operation of the ribs 84e and 84d, the air between the pair of ribs 84e and the air between the pair of ribs 84d flow in the direction opposite to the operation direction of the connecting member 84, i.e., in the direction of the arrow 90. Since the connecting member 84 shown in FIG. 8 is the perspective view in the state observed from the bottom side, the direction in which the connecting member 84 is driven upward (on the sound emitting side) is shown in the downward arrow by the arrow in FIG. 8. Thereby, the wind is generated around the inner and outer peripheral walls of the connecting member 84 respectively. On the contrary, when the connecting member 84 is driven downward (on the side opposite to the sound emitting side), by the operation of the ribs 84e and 84d, the air between the pair of ribs 84e and the air between the pair of ribs 84d flow to the direction opposite to the operation direction of the connecting member 84, i.e., the direction of the arrow 91. Thereby, the wind is generated around the inner and outer peripheral walls of the connecting member 84 respectively. By generating the wind around the inner and outer peripheral walls of the connecting member 84 by the operation of each of the ribs 84e and 84d, the heat of the voice coil 4 can be efficiently radiated, and the connecting member 84 can be cooled.

Next, such the operation will be explained with reference to FIG. 9.

If the connecting member 84 according to the fourth embodiment is applied to the speaker device 100, the problem explained in the first embodiment can be solved. Instead of the above connecting member 8, the connecting member 84 is applied to the speaker device 100 shown in FIG. 9. The portion of the speaker device 100 to which the connecting member 84 is mounted and the structure thereof are similar to those of the connecting member 8.

When the speaker device 100 is driven and the voice coil bobbin 3 and the like move to the sound emitting side, i.e., in the direction of the arrow 64, by the operation of each of the ribs 84e and 84d, the air around the inner and outer peripheral walls of the cylindrical portion 84a flows to the direction of the arrow 92. Thereby, the wind is generated around the inner and outer peripheral walls of the cylindrical portion 84a respectively. On the contrary, when the speaker device 100 is driven and the voice coil bobbin 3 and the like move to the side opposite to the sound emitting side, i.e., in the direction of the arrow 63, by the operation of each of the ribs 84e and 84d, the air around the inner and outer peripheral walls of the cylindrical portion 84a flows to the direction of the arrow 93. Thereby, the wind is generated around the inner and outer peripheral walls of the cylindrical portion 84a respectively.

At this time, the temperature of the air in the space between the outer peripheral wall of the voice coil bobbin 3 and the inner wall of the connecting member 84 becomes high by the heat generated by the voice coil 4. By the effect of the heat, the temperature of the inner wall of the connecting member 84 becomes high. However, by the wind generated by the above-mentioned operation of each of the ribs 84e and 84d, the bottom surface and the upper surface of the bent portion 84 and the inner peripheral wall and outer peripheral wall of the cylindrical portion 84a are cooled. Thereby, the heat generated in the voice coil 4 can be efficiently radiated. Thus, the temperature of the connecting member 84 does not become so high that the deformation due to the heat occurs.

If the connecting member 84 having the plural ribs 84e and 84d is applied to the speaker device 100, the heat generated in the voice coil 4 can be efficiently radiated, and the connecting member 84 can be effectively cooled. Thereby, it can be prevented that the connecting member 84 is deformed due to the heat. In addition, the adhesion strength of the adhesive 71 fixing the connecting member 84 and the damper 2 and the adhesive 71 fixing the connecting member 84 and the diaphragm 1 never decreases, and it can be prevented that the adhesive 71 peels off the connecting member 84.

In addition, in the speaker device 100, generally, the limit value of the withstand input to the voice coil 4 decreases with the temperature of the voice coil 4 increasing. However, in the fourth embodiment, since the air around the inner and outer peripheral walls of the connecting member 84 is cooled as described above, the inside of the speaker device 100 can be efficiently cooled. Therefore, the limit value of the withstand input to the voice coil 4 can be set to the high value.

Further, as for the above connecting member 84, since the plural ribs 84d are formed on the outer peripheral wall of the cylindrical portion 84a and the plural ribs 84e are formed on the inner peripheral wall of the cylindrical portion 84a respectively, the strength of the connecting member 84 can be further enhanced.

1. A speaker device comprising:
a frame;
a magnetic circuit which includes a pot type yoke mounted on the frame;
a damper which has an outer peripheral edge portion supported by the frame;
a diaphragm which is disposed above the magnetic circuit and which has an outer peripheral edge portion supported by the frame; and
a connecting member which is mounted to the damper and the diaphragm and which movably supports a voice coil bobbin above the magnetic circuit,
wherein an opening serving as an air passage is formed on a side wall of the connecting member.

2. The speaker device according to claim 1, wherein the connecting member has the opening at a position at which air in a vicinity of the voice coil is discharged to a space between the pot type yoke and an inner peripheral edge portion of the frame when the diaphragm is driven in a direction away from the magnetic circuit, and at which the air in the vicinity of the voice coil is discharged to a space between a bottom surface of the diaphragm and an area in a vicinity of an upper end of the frame when the diaphragm is driven in a direction close to the magnetic circuit.

3. The speaker device according to claim 1, wherein plural openings are formed on the side wall of the connecting member with fixed spaces therebetween.

4. The speaker device according to claim 1, wherein the frame has an opening at a position opposite to the outer side wall of the connecting member.

5. A speaker device comprising:
a frame;
a magnetic circuit which includes a pot type yoke mounted on the frame;
a damper which has an outer peripheral edge portion supported by the frame; and
a connecting member which is mounted to the damper and which movably supports a voice coil bobbin above the magnetic circuit,
wherein plural ribs are formed on at least one of an outer peripheral wall and an inner peripheral wall of the connecting member such that a longitudinal direction of the rib is in parallel with a movement direction of the voice coil bobbin.

6. The speaker device according to claim 5, wherein the plural ribs are formed on the connecting member in its circumferential direction with fixed spaces therebetween respectively, and are formed from an area in a vicinity of an upper end of the connecting member to an area in a vicinity of an lower end thereof.
